(19) United States
(12) Patent Application Publication
(10) Pub. No.: US 2018/0105742 A1
(43) Pub. Date: Apr. 19, 2018

(54) RED FLUORESCENT SUBSTANCE AND METHOD FOR PRODUCTION THEREOF

(71) Applicant: Shin-Etsu Chemical Co., Ltd., Tokyo (JP)

(72) Inventor: Masami Kaneyoshi, Echizen-shi (JP)

(73) Assignee: Shin-Etsu Chemical Co., Ltd., Tokyo (JP)

(21) Appl. No.: 15/783,268

(22) Filed: Oct. 13, 2017

(30) Foreign Application Priority Data
Oct. 14, 2016 (JP) 2016-202546

(51) Int. Cl. C09K 11/57; C09K 11/66; C09K 11/67

(52) U.S. Cl. CPC C09K 11/57; C09K 11/675; C09K 11/665

(57) ABSTRACT

A red fluorescent substance includes an Mn-activated complex fluoride represented by the formula (1) below:

A¹₂MF₆:Mn (1)

(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential). The red fluorescent substance has an emission spectrum having a peak between 600 to 650 nm, a fluorescent life time up to 5.0 milliseconds at room temperature, and an internal quantum efficiency at least 0.60 at the time of excitation at 450 nm.

Because of the short fluorescent life time, high emission intensity, and high emission efficiency, the red fluorescent substance is suitable for use in the display device that needs high-speed high-definition rendering.

### CROSS-REFERENCE TO RELATED APPLICATION

This non-provisional application claims priority under 35 U.S.C. § 119(a) on Patent Application No. 2016-202546 filed in Japan on Oct. 14, 2016, the entire contents of which are hereby incorporated by reference.

### TECHNICAL FIELD

The present invention relates to a red fluorescent substance (complex fluoride fluorescent substance) useful for white light emitting diodes (LEDs) and a method for production thereof.

### BACKGROUND ART

White LEDs have recently become in need of a fluorescent substance that emits red light upon excitation by the light ranging from near ultraviolet to blue which corresponds to emission of LED chips. This need has arisen for the white LED to have improved color rendition when it is used as a back-light for liquid crystal displays. Investigations to meet this need are proceeding, and one of them is disclosed in Patent Document 1 (JP-T 2009-528429). It mentions that a promising one among such fluorescent substances is a complex-fluoride fluorescent substance which is composed of a complex fluoride and Mn, the former being represented by the formula A₂MF₆ (in which A stands for Na, K, Rb, or the like) and letter M stands for Si, Ge, Ti, or the like).

The most common and well-known one of the Mn-containing complex-fluoride fluorescent substances is K₂SiF₆:Mn which is composed of K₂SiF₆ (as mother crystal) and Mn added thereto. Recent researches on this fluorescent substance reveals that it has a fluorescent life time of 8.5 milliseconds, which is defined as a length of time required for the fluorescence intensity to decrease to 1/e of that immediately after excitation, where letter e stands for the base of natural logarithm. (The length of time mentioned above is referred to as the 1/e attenuation time.) (See Non-Patent Document 1: M. Kim, W. Park, B. Bang, C. Kim, K. Sohn, J. Mater. Chem. C, vol. 3, page 5484 (2015).) This attenuation time is considerably longer than the fluorescent substances in common use, which is undesirable for display devices designed for high-speed high-definition rendering. For this reason, there has been proposed a red fluorescent substance with manganese which is prepared from mother crystals having a shorter fluorescent life time than before. (See Patent Document 2: JP-A 2016-6166.) Moreover, it has been reported that one of the manganese-added complex fluorides mentioned above has a fluorescent life time of 3.8 milliseconds if it is prepared from Cs₂TiF₆ as mother crystal. (See Non-Patent Document 2: Q. Zhou, Y. Zhou, Y. Liu, Z. Wang, G. Chen, J. Peng, J. Yan, M. Wu, J. Mater. Chem. C, vol. 3, page 9615 (2015).) However, comprehensive investigations covering the emission intensity and efficiency are still in progress.

### CITATION LIST

Patent Document 1: JP-T 2009-528429
Patent Document 2: JP-A 2016-6166
Non-Patent Document 1: M. Kim, W. Park, B. Bang, C. Kim, K. Sohn, J. Mater. Chem. C, vol. 3, page 5484 (2015)
Non-Patent Document 2: Q. Zhou, Y. Zhou, Y. Liu, Z. Wang, G. Chen, J. Peng, J. Yan, M. Wu, J. Mater. Chem. C, vol. 3, page 9615 (2015)

### DISCLOSURE OF INVENTION

It is an object of the present invention to provide a red fluorescent substance for white LEDs, which is a manganese-activating complex fluoride fluorescent substance having a shorter fluorescent life time, greater emission intensity, and better efficiency than conventional ones.

In order to achieve the foregoing object, the present inventors carried out extensive studies, which led to a finding that a manganese-activating complex fluoride fluorescent substance of specific composition has a fluorescent life time (1/e attenuation time) up to 5 milliseconds. The result of the investigation on the composition led to the present invention.

That is to say, the present invention covers the red fluorescent substance and the method for production thereof which are defined as follows.

[1] A red fluorescent substance including an Mn-activated complex fluoride represented by the formula (1) below:

A¹₂MF₆:Mn (1)

(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential), wherein the red fluorescent substance has an emission spectrum having a peak between 600 to 650 nm, a fluorescent life time up to 5.0 milliseconds at room temperature, and an internal quantum efficiency at least 0.60 at the time of excitation at 450 nm.
[2] The red fluorescent substance of Paragraph [1] above wherein the tetravalent elements represented by M in the formula (1) contain Ti which accounts for at least 70% of M in total and the alkali metals represented by A¹ in the formula (1) contain Rb and Cs which, combined together, account for at least 70 mol % of A¹ in total.
[3] The red fluorescent substance of Paragraph [2] above wherein the alkali metals represented by A¹ in the formula (1) contain Cs which accounts for at least 70 mol % of A¹ in total.
[4] The red fluorescent substance of Paragraph [1] above wherein the tetravalent elements represented by M in the formula (1) contain Ge which accounts for at least 70% of M in total and the alkali metals represented by A¹ in the formula (1) contain Na which accounts for at least 70 mol % of A¹ in total.
[5] The red fluorescent substance of any one of Paragraphs [1] to [4] above wherein the Mn-activated complex fluoride contains Mn in such an amount as to account for at least 0.1 mol % and up to than 15 mol % in the total amount of Mn and tetravalent elements M.
[6] A method for producing a red fluorescent substance including an Mn-activated complex fluoride which has been described in any one of Paragraphs [1] to [5] above and which is represented by the formula (1) below:

A¹₂MF₆:Mn (1)

(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential), the method including a first step of incorporating a first solution containing a fluoride of the tetravalent element M in the formula (1) above with a solid manganese compound represented by the formula (2) below:

A²₂MnF₆ (2)

(wherein, symbol A² is one or two or more of alkali metals selected from Li, Na, K, Rb, and Sc), further incorporating a first solution with a second solution and/or a solid compound of the alkali metal A¹, with the second solution containing one or two or more of compounds selected from a fluoride, hydrogenfluoride, nitrate, sulfate, hydrogensulfate, carbonate, hydrogencarbonate, and hydroxide of the alkali metal A¹ in the formula (1) above; a second step for reaction between the fluoride of the tetravalent element M, the alkali metal A¹ compound, and the manganese compound; and a third step for solid-liquid separation and recovery of the solid reaction product containing the Mn-activated complex fluoride represented by the formula (1) above, which results from the foregoing reactions.
[7] The method for producing a red fluorescent substance of Paragraph [6] above, in which the first solution is one which is prepared by dissolving a fluoride of the tetravalent element M in the formula (1) above or a polyfluoroacid in water or by dissolving an oxide, hydroxide, or carbonate of the tetravalent element M in the formula (1) above in water mixed with hydrofluoric acid.
[8] The method for producing a red fluorescent substance of Paragraph [6] or [7] above, wherein the second solution is one which is prepared by dissolving in water one or two or more of compounds selected from a fluoride, hydrogenfluoride, nitrate, sulfate, hydrogensulfate, carbonate, hydrogencarbonate, and hydroxide of the alkali metal A¹ in the formula (1) above.
[9] The method for producing a red fluorescent substance of any one of Paragraphs [6] to [8] above, wherein the first solution is incorporated with the manganese compound in such a way that the tetravalent element M and the Mn are present in a molar ratio of Mn/(M+Mn)=from 0.001 to 0.25.
[10] A method for producing a red fluorescent substance including an Mn-activated complex fluoride which has been described in any one of Paragraphs [1] to [5] above and which is represented by the formula (1) below:

A¹₂MF₆:Mn (1)

(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential) the method including a first step of mixing together a complex fluoride (in solid form) represented by the formula (3) below:

A¹₂MF₆ (3)

(wherein, letter M is one or two or more of tetravalent elements (substantially free of Mn) selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential) and a manganese compound (in solid form) represented by the formula (4) below:

A³₂MnF₆ (4)

(wherein, symbol A³ is one or two or more of alkali metals selected from Na, K, Rb, and Cs) and a second step of heating the resulting mixture at at least 100° C. and up to 500° C., thereby giving the Mn-activated complex fluoride represented by the formula (1) above.
[11] The method for producing a red fluorescent substance of Paragraph [10] above, the method including heating the foregoing mixture with a hydrogenfluoride (in solid form) represented by the formula (5) below:

A⁴F.nHF (5)

(wherein, symbol A⁴ is one or two or more of alkali metal or ammonium selected from Li, Na, K, Rb, and NH₄; and n is a number of 0.7 to 4.)
[12] The method for producing a red fluorescent substance of Paragraph [10] or [11] above, in which the tetravalent element M and the Mn are present in a molar ratio of Mn/(M+Mn)=0.001 to 0.25.

### Advantageous Effects of the Invention

The present invention provides a red fluorescent substance which, owing to its rather short fluorescent life time, high emission intensity, and high emission efficiency, is able to convert LED's light, ranging from near ultraviolet to blue, into red light. Thus, the red fluorescent substance will find use in the field of display device requiring high-speed high-definition rendering.

### BRIEF DESCRIPTION OF THE DRAWINGS

FIG. 1 is a schematic sectional view depicting an example of the reactor employed in an example of the present invention;

FIG. 2 is a graph depicting the fluorescence emission and excitation spectrum which were given by the red fluorescent substance in Example 1; and

FIG. 3 is a graph depicting the fluorescence emission and excitation spectrum which were given by the red fluorescent substance in Example 4.

### DESCRIPTION OF THE PREFERRED EMBODIMENTS

The following is a detailed description of the red fluorescent substance according to the present invention.

The fluorescent substance according to the present invention has an emission spectrum having a peak between 600 to 650 nm, a fluorescent life time up to 5.0 milliseconds at room temperature, and an internal quantum efficiency at least 0.60 under excitation by blue light at 450 nm. The fluorescence life time mentioned above is obtained by analyzing how the intensity of fluorescence emission from a sample changes with time after rapidly pulsating excitation light. It is usually defined as time required for the initial intensity to attenuate to 1/e (where letter e is the base of natural logarithm). This definition is adopted in the present invention.

The red fluorescent substance according to the present invention has an emission peak ranging from 600 to 650 nm. The one with an emission peak shorter than 600 nm will assume an orangy color; and the one with an emission peak longer than 650 nm will be less sensitive to human eyes.

The red fluorescent substance according to the present invention needs to have an internal quantum efficiency at least 0.60 under excitation with blue light at 450 nm. An internal quantum efficiency lower than this value is not enough for blue light to be converted into red light, with blue light being wasted by absorption. A desirable value is at least 0.65, preferably at least 0.70. Incidentally, the theoretical upper limit of the internal quantum efficiency is 1.00; however, the practical upper limit is approximately 0.98.

As mentioned above, the red fluorescent substance according to the present invention should have a fluorescent life time up to 5.0 milliseconds. The one having a fluorescent life time longer than this limit is not desirable when it is applied to a display device for high-speed high-definition rendering, because it is incapable of complete separation of images in series or emitted light in scanning lines between adjacent regions. A preferable fluorescent life time is up to 4.5 milliseconds. Although no lower limit exists, it is usually at least 1 milliseconds in the case where manganese is used for the emission center in pursuit of red light emission with high color purity.

The red fluorescent substance according to the present invention is one which includes an Mn-activated complex fluoride represented by the formula (1) below:

A¹₂MF₆:Mn (1)

(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential.)

In general, the Mn-activated complex fluoride may have any alkali metal or tetravalent element which is selected without specific restrictions; however, the one according to the present invention should essentially contain Ti or Ge as the tetravalent element M and also contain at least one of Na, Rb, and Cs as the alkali metal A¹. This condition is necessary for the fluorescent life time to be up to 5.0 milliseconds at room temperature.

There are no specific restrictions as to the combination of the alkali metal M and the alkali metal A¹ in the formula (1); however, the combination specified by [A] or [B] in the following is preferable.

[A] In the formula (1) above, the tetravalent element represented by M contains Ti in such an amount as to account for at least 70 mol % of the total amount of M, and the alkali metal represented by A¹ contains Rb and Cs all together in such an amount as to account for at least 70 mol % of the total amount of A¹.
[B] In the formula (1) above, the tetravalent element represented by M contains Ge in such an amount as to account for at least 70 mol % of the total amount of M, and the alkali metal represented by A¹ contains Na in such an amount as to account for at least 70 mol % of the total amount of A¹.

In the combination specified by [A], A₁ desirably contains Cs in such an amount as to account for at least 70 mol % of the total amount of A₁.

Moreover, more preferable examples of the Mn-activated complex fluoride represented by the formula (1) above include Cs₂TiF₆:Mn and Na₂GeF₆:Mn, which do not contain other elements as much as possible.

The Mn-activated complex fluoride should preferably contain manganese (Mn⁴⁺) as the emission center in an amount of at least 0.1 mol % and up to 15 mol % in the total amount of Mn and tetravalent element M (as mother crystal). The Mn⁴⁺ less than 0.1 mol % is not enough for the satisfactory absorption of exciting light; and the Mn⁴⁺ more than 15 mol % is detrimental to emission efficiency. An amount of 0.5 to 10 mol % is preferable, and an amount of 1 to 7 mol % is more preferable.

The red fluorescent substance according to the present invention may be produced by the method involving precipitation. This method starts from preparing a first solution and a second solution and/or a solid. The first solution is a solution which contains a fluoride of the tetravalent element M in the formula (1) above. (letter M is one or at least two species selected from Si, Ti, Zr, Hf, Ge, and Sn, with Ti and Ge being essential.) The second solution is a solution which contains any one compound selected from a fluoride, hydrogenfluoride, nitrate, sulfate, hydrogensulfate, carbonate, hydrogen carbonate, and hydroxide of the alkali metal A¹ in the formula (1) above (where symbol A¹ is one or at least two species selected from Li, Na, K, Rb, and Cs, with at least one of Na, Rb, and Cs being essential). The solid is a compound of the alkali metal A¹.

The first solution mentioned above is an aqueous solution. It is usually prepared by dissolving in water a fluoride of the tetravalent element M or a polyfluoroacid such as hexafluorotitanic acid (stated differently, titanium hydrofluoric acid or H₂TiF₆). The water may optionally contain an adequate amount of hydrogenfluoride (or hydrofluoric acid). The first solution may also be prepared by dissolving in water an oxide, hydroxide, or carbonate of the tetravalent element M (mentioned above) together with an aqueous solution of hydrofluoric acid (HF). The solution prepared in this manner will also be an aqueous solution which substantially contains a fluoride of the tetravalent element M or a salt of polyfluoroacid.

The first solution should preferably contain the tetravalent element M in an amount of 0.1 to 3 mol/liter, especially 0.2 to 1.5 mollliter. Moreover, the solution should preferably be prepared in such a way that it contains free hydrogenfluoride in an amount of 0 to 25 mollliter, especially 0.1 to 20 mol/liter, with the molar ratio of fluorine to the tetravalent element M being at least 4, preferably at least 6. In other words, it is desirable to add the aqueous solution of hydrofluoric acid in consideration of the foregoing concentration in the case where a fluoride of the tetravalent element M or polyfluoroacid is employed. It is also desirable to add hydrofluoric acid in an amount more than necessary for the tetravalent element M to completely change into a fluoride in the case where an oxide, hydroxide, or carbonate of the tetravalent element M is dissolved in hydrofluoric acid. The molar ratio of fluorine to the tetravalent element M should be up to 100. Fluorine in an excess amount (exceeding this molar ratio) will result in reduced yields because of the excessively high solubility of the intended product.

On the other hand, the second solution is an aqueous solution which is prepared by dissolving in water one or two or more of compounds selected from a fluoride A¹f′, hydrogenfluoride A¹HF₂, nitrate A¹NO₃, sulfate A¹₂SO₄, hydrogensulfate A¹HSO₄, carbonate A¹₂CO₃, hydrogencarbonate A¹HCO₃, and hydroxide A¹OH of the alkali metal A¹ mentioned above (in which symbol A¹ is one or at least two species selected from Li, Na, K, Rb, and Cs, with at least one of Na, Rb, and Cs being essential). In this case, hydrogenfluoride (or aqueous solution of hydrofluoric acid) may optionally be added. The second solution should preferably contain the compound of the alkali metal A¹ in an amount at least 0.02 mol/liter, especially at least 0.05 mol/liter. The alkali metal A¹ in a concentration lower than this limit will give rise to the complex fluoride which does not precipitate (remaining dissolved without being recovered) because of its excessively low concentration. The upper limit of the concentration is up to 10 mol/liter, although it is not specifically restricted. Moreover, the second solution may optionally be prepared by heating above room temperature (e.g., 20° C.) and up to 100° C., preferably in the range of 20° C. to 80° C.

As mentioned above, the second solution may be used in combination with the compound (in solid form) of the alkali metal A¹ mentioned above. Moreover, the second solution mentioned above may be replaced by the compound (in solid form) of the alkali metal A¹ mentioned above. The compound (in solid form) of the alkali metal A¹ mentioned above may be selected from fluoride A¹F, hydrogenfluoride A¹HF₂, nitrate A¹NO₃, sulfate A¹₂SO₄, hydrogensulfate A¹HSO₄, carbonate A¹₂CO₃, hydrogencarbonate A¹HCO₃, and hydroxide A¹OH.

In the next step, the first solution which has been prepared as mentioned above is incorporated with a manganese compound (in solid form) which is represented by the formula (2) below.

A²₂MnF₆ (2)

(wherein, symbol A² is one or two or more of alkali metals selected from Li, Na, K, Rb, and Cs). The manganese compound should be added in such an amount that the molar ratio of Mn to the tetravalent metal M and Mn combined together is Mn/(M+Mn)=0.001 to 0.25, preferably 0.005 to 0.15, more preferably 0.01 to 0.1. This ratio correlates to the ratio of Mn to the tetravalent element (represented by M) in the resulting complex fluoride fluorescent substance. This ratio should be properly adjusted so that the resulting Mn-activated complex fluoride contains manganese (Mn⁴⁺) in such an amount that the ratio of Mn to the total amount of Mn and the tetravalent element M in mother crystal is at least 0.1 mol % and up to 15 mol %.

The next step includes mixing the first solution (which has been incorporated with the manganese compound represented by the formula (2) above) with the second solution and/or the compound (in solid form) of the alkali metal A¹ mentioned above, thereby bringing about a reaction between the fluoride of the tetravalent element M and the compound of the alkali metal A². The two reactants should be mixed slowly and carefully because the mixing is accompanied by heat generation. The reaction time is usually 10 seconds to 1 hour. This reaction yields a solid product (in the form of precipitates). This reaction product is separated from mother liquor by filtration, centrifugation, decantation, or the like, to give a solid product containing the Mn-activated complex fluoride represented by the formula (1) above. This solid product is the red fluorescent substance according to the present invention. Incidentally, the solid product obtained after solid-liquid separation may optionally undergo washing, solvent replacement, or vacuum drying.

The mixing of the first solution and the second solution should be carried out in such a way that the molar ratio A¹/M=2.0 to 5.0, particularly 2.2 to 4.0, where M is the tetravalent element M in the first solution and A¹ is the alkali metal in the second solution and/or the solid. With the molar ratio smaller than 2.0, the amount of A¹ is insufficient for the complex fluoride to precipitate completely. The molar ratio larger than 5.0 does not produce any advantage.

The red fluorescent substance according to the present invention may also be produced by heating a powdery mixture of raw materials, including a complex fluoride (in solid form) and a manganese compound (in solid form). The complex fluoride is represented by the formula (3) below.

A¹₂MF₆ (3)

(wherein, letter M is one or two or more of tetravalent elements (substantially free of Mn) selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential.)

The manganese compound is represented by the formula (4) below.

A³₂MnF₆ (4)

(wherein, symbol A³ is one or two or more of alkali metals selected from Na, K, Rb, and Cs.)

The complex fluoride (free of Mn) represented by the formula (3) above may be commercial one. Alternatively, it may be prepared by precipitation without addition of Mn according to Reference Example 2 (given later) or JP-A 2012-225436 (Patent Document 3). It may also be prepared by heating a mixture of a fluoride of the tetravalent element M and a fluoride of the alkali metal A¹.

The complex fluoride of the tetravalent metal M (free of Mn) represented by the formula (3) above and the manganese compound represented by the formula (4) above should be mixed together in such a ratio that the amount of the tetravalent metal M is 1 mol and the amount of Mn is 0.001 to 0.25 mol, preferably 0.005 to 0.15 mol, more preferably 0.01 to 0.1 mol. If this mixing ratio is lower than 0.001 mol, the resulting fluorescent substance will not have satisfactory light emission characteristics because of the excessively small amount of activating Mn. By contrast, a high mixing ratio exceeding 0.25 mol will deteriorate the light emission characteristics. An adequately adjusted mixing ratio mentioned above is a key to the Mn-activated complex fluoride in which manganese (Mn⁴⁺) accounts for at least 0.1 mol % and up to 15 mol % in the total amount of Mn and the tetravalent element M in mother crystal as mentioned above. Incidentally, the mixing of the raw materials may be accomplished by shaking or turning raw materials in a polyethylene bag or the like, by turning a lidded polyethylene container or the like holding raw materials on a locking mixer or tumbler mixer, or by grinding and mixing raw materials in a mortar.

The mixture which has been prepared as mentioned above is subsequently heated for reaction between the two reactants. This reaction may be promoted with the help of a hydrogenfluoride (in solid form) represented by the formula (5) below:

A⁴F.nMF (5)

(where, symbol A⁴ is one or two or more of alkali metal or ammonium selected from Li, Na, K, Rb, and NH₄, and n is a number of 0.7 to 4.) Examples of the hydrogenfluoride include ammonium hydrogenfluoride (NH₄HF₂), sodium hydrogenfluoride (NaHF₂), potassium hydrogenfluoride (KHF₂), and KF.2HF, which are commercially available except for the last. The hydrogenfluoride should be added such that the amount of A⁴ mentioned above is 0 to 2.0 mol, preferably 0.1 to 1.5 mol, for 1 mol of M in the formula (3) above as main component metal. An excess amount more than 2.0 mol has no merit in production of the fluorescent substance. The reaction product will be a lump which is hard to break. There are no specific limitations in the method of mixing the hydrogenfluorides. Mixing should be completed within a short time and mixing with intense grinding should be avoided to prevent heat generation during mixing.

It is desirable to use the hydrogenfluoride mentioned above in combination with a reaction accelerator, such as nitrate, sulfate, hydrogen sulfate, and fluoride of an alkali metal. The reaction accelerator should be used in an amount (in terms of mol) not exceeding the amount of the hydrogenfluoride.

The heating temperature should be 100° C. to 500° C., preferably 150° C. to 450° C., and more preferably 170° C. to 400° C. Heating should be carried out in atmospheric air, nitrogen, argon, or vacuum. A reducing atmosphere containing hydrogen is not desirable because it reduces manganese, thereby adversely affecting the light emission characteristics. Heating may be accomplished by using a closed container (to be heated in a dryer or oven) or a vented container (to be directly heated with a heater). The closed container for heating should have a fluoroplastic lining to avoid the reaction product from coming into direct contact with container. A container made of fluoroplastics is suitable for heating up to 270° C. although there are no specific limitations. A container made of ceramics, such as alumina, magnesia, or magnesium aluminum spinel, is desirable for reaction above 270° C.

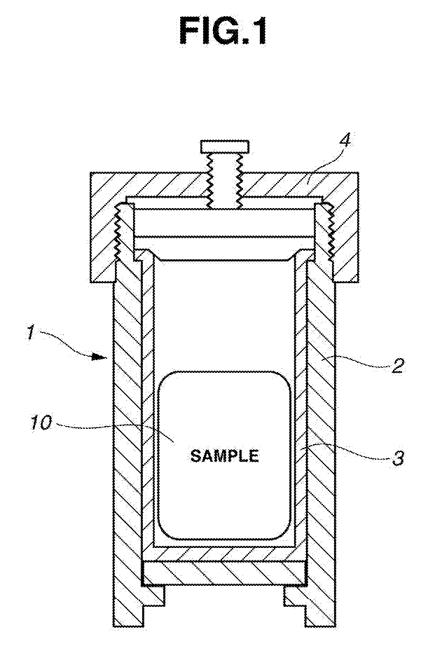

A typical example of the preferable reactor is depicted in FIG. 1. A reactor 1 includes a main body 2 of stainless steel and an inner layer 3 of polytetrafluoroethylene. A sample 10, which is a powdery mixture of reactants, is heated for reaction in this reactor. A lid 4 is also made of stainless steel.

Heating of the reactants gives rise to a reaction product which mainly includes the red fluorescent substance or the Mn-activated complex fluoride represented by the formula (1) above as a target and which also contains unreacted hexafluoromanganate. The reaction product may also contain residues of the hydrogenfluoride added to accelerate reactions. Such impurities should be removed by washing.

The washing may be accomplished with the help of a solution of inorganic acid, such as hydrochloric acid, nitric acid, and hydrofluoric acid, or a solution of fluoride, such as ammonium fluoride and potassium fluoride. A solution of hydrofluoric acid or ammonium fluoride is preferable. The washing fluid may contain a water-soluble organic solvent, such as ethanol and acetone, in order to prevent the fluorescent component from dissolution during washing. The same object as above may be achieved by using a washing liquid which contains (dissolved therein) A¹₂MF₆ represented by the formula (3) above which is the raw material. The washed solid product is dried to give the desired product in the usual way.

### EXAMPLES

In what follows, the present invention will be described in more detail with reference to Examples and Reference Examples, which are not intended to restrict the scope thereof.

### Reference Example 1

(Preparation of K₂MnF₆)

A sample of K₂MnF₆ was prepared as follows in accordance with the method described in the Course for New Experimental Chemistry, vol. 8 “Synthesis of Inorganic Compounds, part III,” pp. 1166, Compiled by Japan Chemical Society, Issued by Maruzen Co., Ltd., 1977.

A reaction vessel of polyvinyl chloride resin was prepared which has two chambers separated by an ion exchange membrane of fluoroplastics placed at the center of the vessel, with each chamber being provided with an anode and a cathode, both made of platinum plate. One chamber with the anode was filled with an aqueous solution of hydrofluoric acid containing manganese (ii) fluoride dissolved therein. The other chamber with the cathode was filled with an aqueous solution of hydrofluoric acid. With both of the electrodes connected to a power source, the solutions underwent electrolysis at a voltage of 3 V with a current of 0.75 A. After electrolysis, the reaction solution in the chamber with the anode was given in excess an aqueous solution of hydrofluoric acid saturated with potassium fluoride. The resulting reaction product, which is a yellowish solid, was recovered by filtration. Thus there was obtained K₂MnF₆.

### Example 1

The first step started with charging a two-liter polyethylene beaker with 232 cm³ of 40 wt % titanium hydrofluoric acid (40% H₂TiF₆, from Morita Chemical Industries Co., Ltd.), 454 cm³ of 50% HF (50% high-purity hydrofluoric acid semiconductor (SA grade), from Stella Chemifa Corporation), and 570 cm³ of pure water. After stirring and mixing, there was obtained a solution which was designated as the first solution. The next step included charging a one-liter polyethylene beaker (which had been left in an iced water bath) with 720 g (407 cm³) of aqueous solution of cesium hydroxide (containing 50 wt % CsOH, from Nihon Kagaku Sangyo Co., Ltd.). The beaker was further charged with 248 cm³ of water and then with 89 cm³ of 50% HF little by little with stirring. After continued stirring and cooling, there was obtained a solution which was designated as the second solution. The first solution was given 11.9 g of K₂MnF₆ (in powder form) prepared in Reference Example 1, with stirring for complete dissolution. The resulting solution was given the second solution slowly over approximately 1.5 minutes. After continued stiffing for 12 minutes, there were obtained light orange-colored precipitates. The precipitates were filtered off through a Buchner funnel and then washed three times with a small amount of acetone just enough to moisten the precipitates. After vacuum drying, there was obtained the desired product in a yield of 348.1 g.

The thus obtained product was found by powder X-ray diffractometry to have the crystal structure corresponding to Cs₂TiF₆ (JCPDS database No. 00-051-0612). A portion of the product was completely dissolved in dilute hydrochloric acid, and the resulting solution was analyzed by inductively coupled plasma (ICP) emission spectroscopy to determine the amount of Mn, Ti, K and Cs. Based on the result of analysis, the molar ratio Mn/(Mn+Ti) was calculated and the content of K and Cs was also calculated. The results are indicated in Table 1. Calculations from the data in Table 1 indicated that Cs accounts for at least 99 mol % in the total amount of alkali metals. The resulting product was examined for particle size distribution by the laser diffraction method of air flow dispersion type (with HELOS & RODOS, made by Sympatec Co., Ltd.). The results are indicated in Table 2. Particles that are smaller or equal to the D10, D50, and D90 values account for 10, 50, and 90 vol % of total powder, respectively.

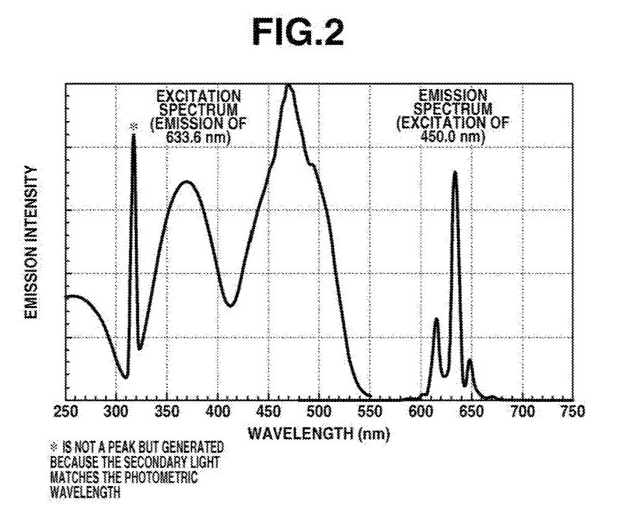

The resulting product was also examined for emission spectrum and excitation spectrum with the help of a fluorometer FP6500 (from JASCO Corporation). The results are indicated in FIG. 2. It should be noted that the emission spectrum has the maximum peak at 633.6 nm. The resulting product was also examined for absorption ratio and quantum efficiency for the excitation wavelength of 450 nm and 468 nm, with the help of QE1100 for measurement of quantum efficiency (from Outsuka Electronisc Co., LTD.) The results are indicated in Table 2.

Moreover, the product was examined for emission attenuation with the help of a spectrofluorometer LS55 (from Perkin Elmer Inc.) so as to evaluate the fluorescent life time. Measurement was carried out at room temperature with the excitation light of 450 nm. The results are indicated in Table 2.

### Example 2

The same procedure as Example 1 was repeated. The first step started with charging a two-liter polyethylene beaker with 348 cm³ of 40% H₂TiF₆, 454 cm³ of 50% HF, and 570 cm³ of pure water. After stirring and mixing, there was obtained a solution which was designated as the first solution. As in Example 1, the next step included charging a one-liter polyethylene beaker (which had been left in an iced water bath) with 1079 g 50% CsOH solution and 134 cm³ of 50% HF with stirring. After stiffing and mixing, there was obtained a solution which was designated as the second solution. The first solution was given 17.8 g of K₂MnF₆ (in powder form) prepared in Reference Example 1, with stirring for complete dissolution. The resulting solution was given the second solution slowly over approximately 1.5 minutes. After continued stirring for 12 minutes, there were obtained light orange-colored precipitates. The precipitates were filtered off through a Buchner funnel. After the same procedure as in Example 1, there was obtained the desired product in a yield of 533.1 g, which has the crystal structure corresponding to Cs₂TiF₆. The resulting product was examined in the same way as in Example 1 to determine the amount of Mn, Ti, K, and Cs, and to measure the particle size distribution, and to identify the optical properties. The results are indicated in Tables 1 and 2. Calculations from the results indicate that the amount of Cs accounts for at least 99 mol % in the total amount of alkali metals. The product gave the emission spectrum which has the maximum peak at 633.6 nm as in Example 1.

### Example 3

The first step started with charging a one-liter polyethylene beaker with 22 cm³ of 40% H₂TiF₆, 162 cm³ of 50% HF, and 99 cm³ of pure water. After stirring and mixing, there was obtained a solution which was designated as the first solution. The next step included charging a 0.5-liter polyethylene beaker with 169 cm³ of pure water and 26.15 g of rubidium carbonate Rb₂CO₃ (from Rare Metallic Co., LTD.), followed by stiffing for dispersion (partial dissolution). The resulting solution was given 16.8 cm³ of 50% HF little by little with stirring while avoiding excessive bubbling. After complete dissolution and cooling, there was obtained a solution which was designated as the second solution. The first solution was given 1.12 g of K₂MnF₆ (in powder form) prepared in Reference Example 1, with stirring for complete dissolution. The resulting solution was given the second solution slowly over approximately 1.5 minutes. After continued stirring for 12 minutes, there were obtained light orange-colored precipitates. The precipitates were filtered off through a Buchner funnel. After the same procedure as in Example 1, there was obtained the desired product in a yield of 20.50 g, which has the crystal structure corresponding to Rb₂TiF₆. The resulting product was examined in the same way as in Example 1 to determine the amount of Mn, Ti, K, and Rb, and to measure the particle size distribution, and to identify the optical properties. The results are indicated in Tables 1 and 2. Calculations from the results indicate that the amount of Rb accounts for at least 99 mol % in the total amount of alkali metals and that the emission spectrum has the maximum peak at 632.8 nm.

### Example 4

The first step started with sequentially charging a one-liter polyethylene beaker with 250 cm³ of pure water and 15.06 g of germanium oxide GeO₂ (from Rare Metallic Co., LTD.), followed by stirring for dispersion. The beaker was further charged with 140 cm³ of 50% HF, little by little with stirring, so that the oxide dissolved completely. The resulting solution was designated as the first solution. In the second step, a powder of sodium fluoride (18.14 g) was made ready from a lump of sodium fluoride NaF (first grade, from Wako Pure Chemical Industries, Ltd.) by crushing and sieving through a screen of polyamide resin having an opening of 250 μm. In the third step, the first solution was given 2.14 g of K₂MnF₄ powder prepared in Reference Example 1, with stirring for complete dissolution. Subsequently, it was further given the sodium fluoride powder prepared as mentioned above. After stirring for 15 minutes, there was obtained a light orange-colored solid. This reaction product was filtered off through a Buchner funnel. After repeating the same procedure as in Example 1, there was obtained the desired product in a yield of 29.17 g.

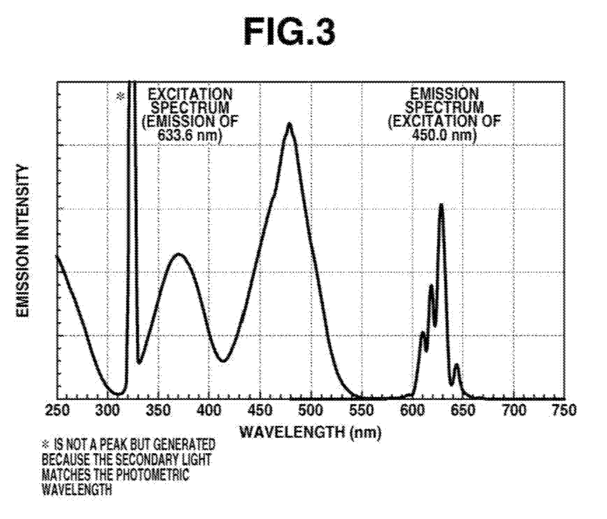

The product obtained as mentioned above was found by powder X-ray diffractometry to have the crystal structure corresponding to Na₂GeF₆ (JCPDS database No. 00-035-0816). The product was examined to determine the amount of Mn, Ge, K, and Na, to measure the particle size distribution, and to identify the emission properties. It gave the emission spectrum which has the maximum peak at 627.8 nm. Its emission spectrum and excitation spectrum are depicted in FIG. 3, and its other data are indicated in Tables 1 and 2. Calculations from these data indicate that Na accounts for at least 99 mol % of the total amount of alkali metal.

### Reference Example 2

(Preparation of Na₂GeF₆)

A five-liter polyethylene beaker was charged with 1000 cm³ of pure water and then 313.8 g of germanium oxide, followed by stirring for complete dispersion. The resulting solution was given 667 cm³ of 50% HF slowly little by little with stirring. The resulting uniform solution of the oxide was given pure water so that the total amount becomes 3000 cm³. The resulting solution was designated as the first solution. Apart from the foregoing step, a two-liter polyethylene beaker was charged with 526.0 g of NaCl (special reagent grade, from Wako Pure Chemical Industries, Ltd.) and pure water as much as necessary to make 2000 cm³ of solution. The resulting solution is designated as the second solution. The first solution was given the second solution with stirring over approximately 2 minutes. Subsequent stiffing was continued for 12 minutes. There was obtained a white translucent solid. The resulting solid product was filtered out through a Buchner funnel, followed by washing with water, washing with acetone, and vacuum drying. Thus there was obtained Na₂GeF₆ in a yield of 657.1 g.

### Example 5

The powder of K₂MnF₆ (6.23 g) prepared in Reference Example 1 and the powder of Na₂GeF₆ (48.8 g) prepared in Reference Example 2 were mixed together in a zippered polyethylene bag by shaking and turning over 5 minutes. The resulting powder mixture was further mixed with sodium hydrogenfluoride NaHF₂ (10.94 g) (Grade 1, from Wako Pure Chemical Industries, Ltd.) and hydrofluoride corresponding to KF.2HF (5.77 g) (acid potassium fluoride (S) from Stella Chemifa Corporation). The mixing ratio based on 1 mol of Ge is 0.85 mol for NaHF₂ and 0.28 mol for KF.2HF.

The powdery mixture obtained as mentioned above was placed in the double-walled container 1 depicted in FIG. 1. Then, the container was heated in an oven at 250° C. for 12 hours and then allowed to cool by itself. The container 1 includes the container proper (or outer wall) 2 of stainless steel (SUS) and the inner layer 3 of polytetrafluoroethylene. The container 1 holding the powdery mixture 10 was tightly closed with the lid 4 of stainless steel. The reaction product obtained after cooling was partly powdery and mostly lumpy. They were mixed together, with lumps roughly crushed.

The reaction product mentioned above was washed by dipping for 10 minutes in a cleaning solution including 100 cm³ of 50% HF and 4.1 of Na₂GeF₆ dissolved therein. Washing was followed by standing so that there were obtained powdery precipitates, with lumps completely disintegrated. The powdery precipitates were filtered off through a Buchner funnel and washed with the remainder of the washing solution. The precipitates were washed further with acetone and finally recovered for vacuum drying. Thus there was obtained a powdery product in a yield of 53.8 g. This product was found to have a crystal structure corresponding to Na₂GeF₆. The product was examined in the same way as in Examples 1 and 4 to determine the amount of Mn, Ge, K, and Na, to measure the particle size distribution, and to identify the optical properties. The results are indicated in Tables 1 and 2. Calculations from the results indicate that the amount of Na accounts for approximately 99 mol % of the total amount of the alkali metals. The product gave the emission spectrum which has the maximum peak at 627.8 nm as in Example 4.

TABLE 1

| | Mn | Ti | Ge | Mn/(Mn + Ti) | Mn/(Mn + Ge) | K | Cs | Rb | Na |
|---|---|---|---|---|---|---|---|---|---|
| | (wt %) | (wt %) | (wt %) | (mol ratio) | (mol ratio) | (wt %) | (wt %) | (wt %) | (wt %) |
| Example 1 | 0.73 | 10.60 | — | 0.0569 | — | 0.02 | 63.8 | — | — |
| Example 2 | 0.70 | 10.57 | — | 0.0545 | — | 0.02 | 63.5 | — | — |
| Example 3 | 1.11 | 13.64 | — | 0.0662 | — | 0.01 | — | 53.4 | — |
| Example 4 | 0.40 | — | 30.74 | — | 0.0169 | 0.02 | — | — | 20.45 |
| Example 5 | 0.55 | — | 30.55 | — | 0.0232 | 0.27 | — | — | 20.80 |

TABLE 2

| | Particle size | | | Excitation at 450 nm | | Excitation at 468 nm | | |
|---|---|---|---|---|---|---|---|---|
| | distribution | | | | Internal | | Internal | Fluorescent |
| | (μm) | | | | quantum | | quantum | life time |
| | D10 | D50 | D90 | Absorptivity | efficiency | Absorptivity | efficiency | (milliseconds) |
| Example 1 | 24.4 | 58.7 | 97.9 | 0.716 | 0.781 | 0.791 | 0.804 | 4.3 |
| Example 2 | 9.0 | 34.2 | 69.3 | 0.635 | 0.769 | 0.712 | 0.809 | 4.4 |
| Example 3 | 9.0 | 42.6 | 100.8 | 0.649 | 0.746 | 0.707 | 0.788 | 4.8 |
| Example 4 | 2.9 | 22.4 | 56.3 | 0.403 | 0.682 | 0.437 | 0.723 | 4.7 |
| Example 5 | 2.1 | 17.7 | 86.0 | 0.552 | 0.634 | 0.590 | 0.684 | 4.4 |

It is noted from Table 2 and FIGS. 2 and 3 that the red fluorescent substance according to the present invention is characterized by the high emission intensity and the high emission efficiency. Moreover, it is also characterized by its short fluorescent life time (up to 5 milliseconds). These characteristic properties are desirable for use in the display device that needs high-speed high-definition rendering.

Japanese Patent Application No. 2016-202546 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A red fluorescent substance comprising an Mn-activated complex fluoride represented by the formula (1) below:
A¹₂MF₆:Mn (1)
(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential),
wherein the red fluorescent substance has an emission spectrum having a peak between 600 to 650 nm, a fluorescent life time up to 5.0 milliseconds at room temperature, and an internal quantum efficiency at least 0.60 at the time of excitation at 450 nm.

2. The red fluorescent substance of claim 1, wherein the tetravalent elements represented by M in the formula (1) contain Ti which accounts for at least 70% of M in total and the alkali metals represented by A¹ in the formula (1) contain Rb and Cs which, combined together, account for at least 70 mol % of A¹ in total.

3. The red fluorescent substance of claim 2, wherein the alkali metals represented by A¹ in the formula (1) contain Cs which accounts for at least 70 mol % of A¹ in total.

4. The red fluorescent substance of claim 1, wherein the tetravalent elements represented by M in the formula (1) contain Ge which accounts for at least 70% of M in total and the alkali metals represented by A¹ in the formula (1) contain Na which accounts for at least 70 mol % of A¹ in total.

5. The red fluorescent substance of claim 1, wherein the Mn-activated complex fluoride contains Mn in such an amount as to account for at least 0.1 mol % and up to 15 mol % in the total amount of Mn and tetravalent elements M.

6. A method for producing a red fluorescent substance including an Mn-activated complex fluoride, which has been defined in claim 1 and which is represented by the formula (1) below:
A¹₂MF₆:Mn (1)
(wherein, letter M is one or two or more of tetravalent elements selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential) said method comprising:
a first step of incorporating a first solution containing a fluoride of the tetravalent element M in the formula (1) above with a solid manganese compound represented by the formula (2) below:
A²₂MnF₆ (2)
(wherein, symbol A² is one or two or more of alkali metals selected from Li, Na, K, Rb, and Sc)
further incorporating a first solution with a second solution and/or a solid compound of said alkali metal A¹, with said second solution containing one or two or more of compounds selected from a fluoride, hydrogenfluoride, nitrate, sulfate, hydrogensulfate, carbonate, hydrogencarbonate, and hydroxide of the alkali metal A¹ in the formula (1) above;
a second step for reaction between the fluoride of said tetravalent element M, said alkali metal A¹ compound, and said manganese compound; and
a third step for solid-liquid separation and recovery of the solid reaction product containing the Mn-activated complex fluoride represented by the formula (1) above, which results from the foregoing reactions.

7. The method for producing a red fluorescent substance of claim 6, in which said first solution is one which is prepared by dissolving a fluoride of the tetravalent element M in the formula (1) above or a polyfluoroacid in water or by dissolving an oxide, hydroxide, or carbonate of the tetravalent element M in the formula (1) above in water mixed with hydrofluoric acid.

8. The method for producing a red fluorescent substance of claim 6, wherein said second solution is one which is prepared by dissolving in water one or two or more of compounds selected from a fluoride, hydrogenfluoride, nitrate, sulfate, hydrogensulfate, carbonate, hydrogencarbonate, and hydroxide of the alkali metal A¹ in the formula (1) above.

9. The method for producing a red fluorescent substance of claim 6, wherein said first solution is incorporated with said manganese compound in such a way that said tetravalent element M and said Mn are present in a molar ratio of Mn/(M+Mn)=0.001 to 0.25.

10. A method for producing a red fluorescent substance including an Mn-activated complex fluoride, which has been described in claim 1 and which is represented by the formula (1) below:
A¹₂MF₆:Mn (1)
(wherein, letter M is one or two or more of tetravalent elements (substantially free of Mn) selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential) said method comprising:
a first step of mixing together a complex fluoride (in solid form) represented by the formula (3) below:
A¹₂MF₆ (3)
(wherein, letter M is one or two or more of tetravalent elements (substantially free of Mn) selected from Si, Ti, Zr, Hf, Ge, and Sn, with Ti or Ge being essential; and symbol A¹ is one or two or more of alkali metals selected from Li, Na, K, Rb, and Cs, with at least one of Na, Rb, and Cs being essential)
and a manganese compound (in solid form) represented by the formula (4) below:
A³₂MnF₆ (4)
(wherein, symbol A³ is one or two or more of alkali metals selected from Na, K, Rb, and Cs) and;
a second step of heating the resulting mixture at at least 100° C. and up to 500° C., thereby giving the Mn-activated complex fluoride represented by the formula (1) above.

11. The method for producing a red fluorescent substance of claim 10, said method comprising:
heating the foregoing mixture with a hydrogenfluoride (in solid form) represented by the formula (5) below:
A⁴F.nHF (5)
(wherein, symbol A⁴ is one or two or more of alkali metal or ammonium selected from Li, Na, K, Rb, and NH₄; and n is a number of 0.7 to 4.)

12. The method for producing a red fluorescent substance of claim 10, in which said tetravalent element M and said Mn are present in a molar ratio of Mn/(M+Mn)=0.001 to 0.25.
